(19) United States
(12) Patent Application Publication
(10) Pub. No.: US 2016/0342581 A1
(43) Pub. Date: Nov. 24, 2016

(54) DIGITAL TAGGING SPECIFICATION GENERATION

(71) Applicant: Microsoft Technology Licensing, LLC, Redmond, WA (US)

(72) Inventors: Paul Delgado, Redmond, WA (US); Autumn N. Arbury, Seattle, WA (US)

(21) Appl. No.: 14/720,770

(22) Filed: May 23, 2015

(51) Int. Cl. G06F 17/24; G06F 17/22; G06F 3/0484; G06F 3/0482; G06F 3/0483; G06F 3/0481

(52) U.S. Cl. CPC G06F 17/241; G06F 3/0483; G06F 3/04817; G06F 3/04842; G06F 3/0482; G06F 17/2247; G06F 17/2235

(57) ABSTRACT

Digital tagging specification generating implementations are presented that generally simplify the creation of a digital tagging specification which can employ multiple digital measurement systems without requiring a user to have specific knowledge about any particular system. More particularly, a series of interactive user interface pages are presented to a user that prompts the user to input information employed to generate the digital tagging specification. This information includes images representing web pages that are to be tagged and the identity of digital measurement systems that are to be employed. In addition, for each tag area identified on each image, the information includes the identity of data that is to be captured when a tag associated with the area is triggered, and the triggering event that causes the data to be captured. The user-input information is then used to generate the digital tagging specification.

### BACKGROUND

Capturing and reporting information about a website viewer's activities while visiting a web page is of great value to the website owner and others. This collection and the subsequent analysis of a viewer's activities are often referred to as analytics. The capturing and reporting of information is accomplished by adding tagging code (sometimes referred to as a digital measurement tag or just a tag) to the base code of a web page. Thus, adding tagging code is often referred to as tagging a web page. The tagging code is a set of instructions that is typically read and executed by a viewer's browser. The information specified in these instructions is captured by the browser, and is sent to a data collection system.

There are several existing digital measurement systems that can be employed by a website developer to accomplish the foregoing tagging of a site's web pages. Often more than one such measurement system is employed to tag the web pages of a site. Each of these systems employs proprietary instructions and tags. Thus, a website developer needs to know how to tag a web page in order to capture user behavior for each measurement system that is used on the website.

A digital tagging specification often plays an important role in the process of tagging a website. This specification is a document that includes a set of instructions that is used by a developer as a blueprint to tag a website, thus aiding in the foregoing task. This specification also describes what digital measurement tags to add to collect the desired data.

### SUMMARY

The digital tagging specification generating implementations described herein generate a digital tagging specification for use by a developer to tag a website. In one implementation, a computing device is used to first present a series of interactive user interface pages to a user which prompts the user to input information employed to generate the digital tagging specification. This user-input information is then received from the user. The information includes one or more images representing web pages that are to be tagged with one or more digital measurement tags. The information also includes one or more digital measurement systems that are to be used in tagging the web pages, as well as, for each web page which is to be tagged, one or more tag areas on the image representing the web page where digital measurement tags are to be located. In addition, for each tag area on each image, the aforementioned information includes the identity of data that is to be captured and sent to a specified data collection system when a tag associated with the area is triggered, and the triggering event that causes the data specified by the tag associated with that tag area to be captured and sent. Once the foregoing user-input information is received, a digital tagging specification is generated using the information.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more detailed description that is presented below.

### DESCRIPTION OF THE DRAWINGS

The specific features, aspects, and advantages of the disclosure will become better understood with regard to the following description, appended claims, and accompanying drawings where:

FIG. 1 is a diagram illustrating one implementation, in simplified form, of a system for realizing the digital tagging specification generating implementations described herein.

FIG. 2 is a flow diagram illustrating one implementation of a process for generating a digital tagging specification.

FIG. 3 is a flow diagram illustrating one implementation of a process for generating an image representing a web page identified by a user-specified link (such as a URL) to the web page.

FIG. 4 is a diagram illustrating one implementation, in simplified form, of a system for presenting a series of interactive user interface pages to a user which prompts the user to input the information employed to generate a digital tagging specification.

FIG. 5 is a diagram illustrating one implementation, in simplified form, of an interactive user interface page for presenting an image prompt inviting the user to input an image representing a web page that is to be tagged with one or more digital measurement tags.

FIG. 6 is a diagram illustrating one implementation, in simplified form, of an interactive user interface page for presenting a tag area prompt inviting the user to input the location one or more tag areas on the displayed image where digital measurement tags are to be placed on the web page represented by the image.

FIG. 7 is a diagram illustrating one implementation, in simplified form, of an interactive user interface page for presenting data items associated with a selected tag data icon, and data entry boxes for the user to enter a data item value indicative of a prescribed state of each data item.

FIG. 8 is a diagram depicting a general purpose computing device constituting an exemplary system for use with the digital tagging specification generating implementations described herein.

### DETAILED DESCRIPTION

In the following description reference is made to the accompanying drawings which form a part hereof, and in which are shown, by way of illustration, specific versions in which digital tagging specification generating implementations can be practiced. It is understood that other implementations can be utilized and structural changes can be made without departing from the scope thereof.

It is also noted that for the sake of clarity specific terminology will be resorted to in describing the digital tagging specification generating implementations and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation” means that a particular feature, a particular structure, or particular characteristics described in connection with the implementation can be included in at least one version of the digital tagging specification generating. The appearances of the phrases “in one implementation”, “in another implementation”, “in an exemplary implementation”, and “in an alternate implementation” in various places in the specification are not necessarily all referring to the same implementation, nor are separate or alternative implementations mutually exclusive of other implementations. Yet furthermore, the order of process flow representing one or more implementations of the project information extraction does not inherently indicate any particular order or imply any limitations thereof.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive in a manner similar to the term “comprising” as an open transition word without precluding any additional or other elements.

### 1.0 Digital Tagging Specification Generation

In general, the digital tagging specification generating implementations described herein provide a user-interactive environment which simplifies the creation of a digital tagging specification that can employ multiple digital measurement systems without requiring an individual to have specific knowledge about any particular system. Thus, a user who has little to no knowledge of digital measurement tagging of web pages can create a digital tagging specification.

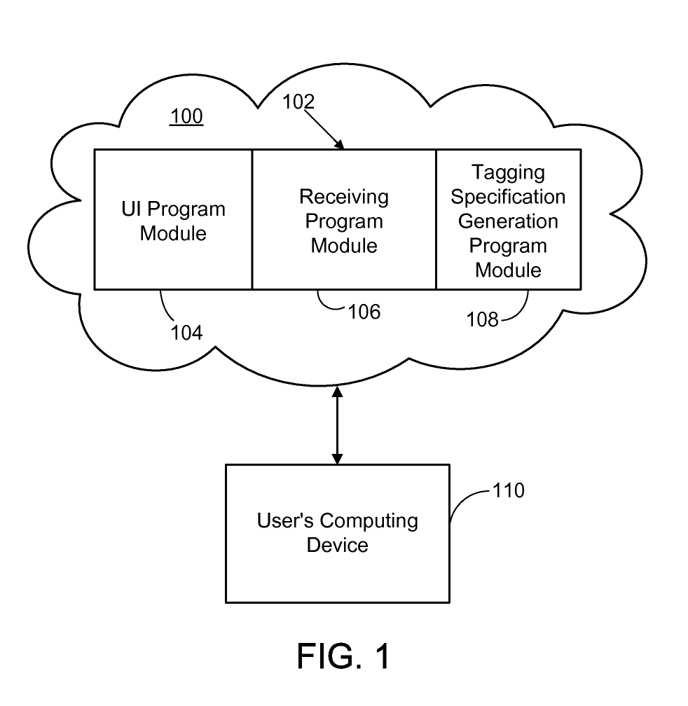

More particularly, referring to FIG. 1, in one exemplary implementation of a system for generating a digital tagging specification, one or more computing devices 100 are employed. Each of these computing devices at least includes a processor, communication interface and memory. If more than one computing device is employed, such as in a cloud computing environment, the computing devices are in communication with each other via a computer network. A computer program 102 having program modules which are executed by the computing device or devices 100 is also included. The computing program includes a user-interface (UI) program module 104, receiving program module 106 for receiving user-input information and a digital tagging specification generation program module 108. The one or more computing devices 100 are in communication (via a computer network such as the Internet) with a user's computing device 110.

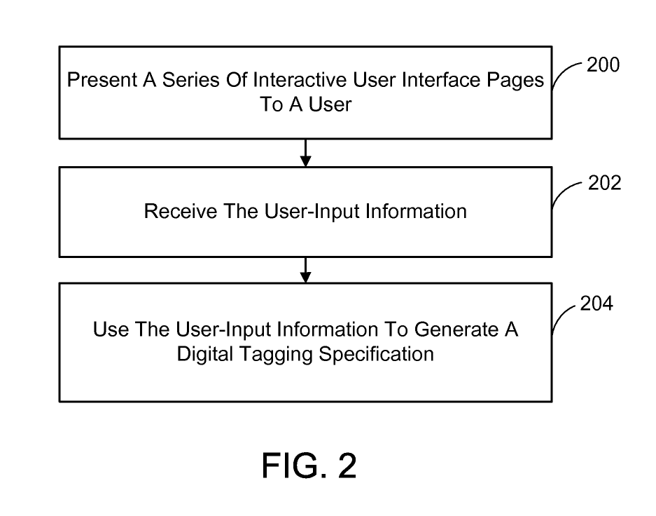

Referring now to FIG. 2, the computing device or devices (100 of FIG. 1) are directed by the program modules of the computer program (102 of FIG. 1) to perform a series of process actions. These process actions include presenting a series of interactive user interface pages to a user (process action 200). These interactive user interface pages prompt the user to input information used to generate the digital tagging specification. The user-input information is then received (process action 202) and used to generate a digital tagging specification (process action 204).

With regard to the user-input information that is solicited and received from the user, it includes:
a) One or more images representing web pages each of which is to be tagged with one or more digital measurement tags;
b) One or more digital measurement systems that are to be used in tagging the one or more web pages;
c) For each web page which is to be tagged, one or more tag areas on the image representing the web page where digital measurement tags are to be located;
d) For each tag area on each image, the identity of data that is to be captured and sent to a data collection system when a tag associated with the area is triggered; and
e) The triggering event which causes the data specified by the tag associated with that tag area to be captured and sent to the specified data collection system.

The foregoing user-input information will be described in more detail in the next few sections. Then, the digital tagging specification generation will be described followed by the aforementioned interactive user interface.

### 1.1 User-Input Information

A series of interactive user interface pages are presented which prompt the user to input information used to generate the digital tagging specification. The user-input information that is solicited and received from the user will now be described.

### 1.1.1 Images

As indicated previously, one or more images representing web pages that are to be digitally tagged with digital measurement tags are solicited and received from the user. In one implementation, these images take the form of one or more sequences of images, where each image sequence represents a series of web pages that it is anticipated a viewer would view in sequential order. In this way it is possible to build a viewer's journey through tagged web pages.

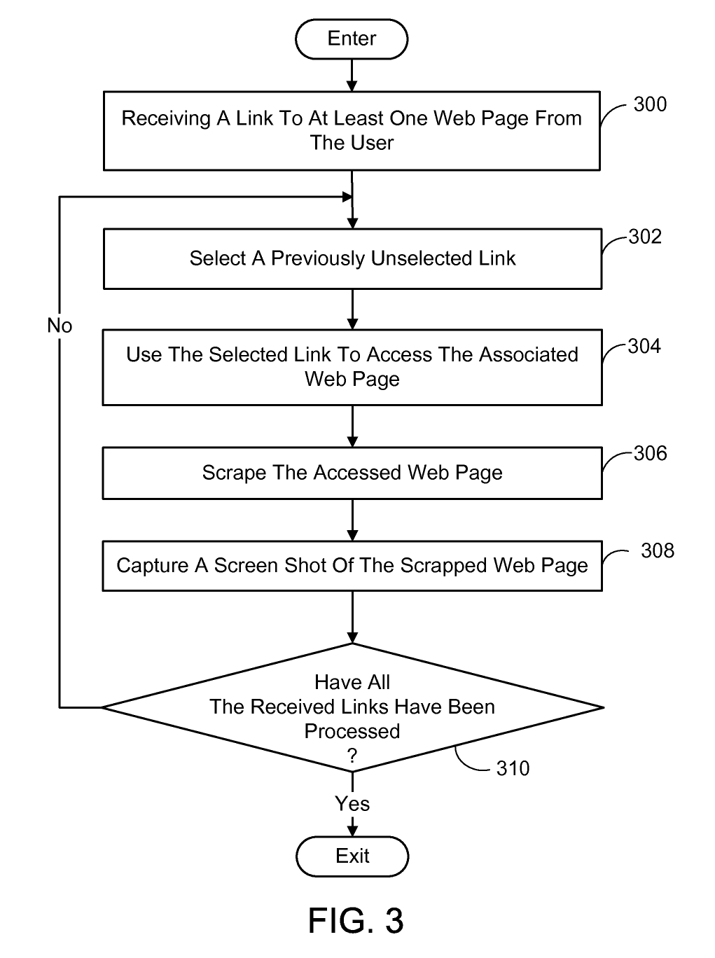

In one implementation, the user uploads the image or images from a file share or their computer. Of course, this presupposes that the user already has images of the web pages that it is desired to tag. However, this may not be the case. To this end, in one implementation, a screen capture feature is included that allows a user to enter a link (such as a URL) to the web page. This feature then captures an image of the page. For example, referring to FIG. 3, in one version this involves first receiving a link to at least one web page from the user (process action 300). Then, a previously unselected one of the links is selected (process action 302). The selected link is then used to access the associated web page (such as via the Internet) in process action 304. The accessed web page is scrapped using conventional methods (process action 306). A screen shot of the scrapped web page is then captured (process action 308). The screen shot represents the aforementioned image. It is next determined if all the received links have been processed (process action 310). If not, process actions 302 through 310 are repeated. Otherwise the procedure ends.

Sometimes the accessed web page includes dynamic content. To accommodate this circumstance, in one version, scraping the accessed web page also includes scrolling the entire web page and loading any dynamic content associated with the webpage before capturing a screen shot of the scrapped page.

### 1.1.2 Digital Measurement Systems

As indicated previously, one or more digital measurement systems that are to be used in tagging the one or more web pages are solicited and received from the user. Many digital measurement systems are available to digitally tag web pages. Often more than one system is employed on a web page or across a series of web pages. As such, the digital tagging specification generating implementations described herein accommodate multiple digital measurement systems and the digital tagging specification that is generated facilitates adding digital measurement tags associated with all these systems.

It is noted that in one implementation, the digital measurement tags associated with a digital measurement system are pre-loaded in a custom structured taxonomy file resident on the aforementioned computing device or devices (100 of FIG. 1). If a new digital measurement system is to be added, its digital measurement tags are included in a new taxonomy file for that system. Each taxonomy file also includes the instructions used to implement the digital measurement tags on web pages.

As will become more apparent in the description of the interactive user interface, in one implementation, a branch logic approach is employed. In general, the user is prompted to select certain icons representing packages identifying digital measurement systems for a specific project or task. The digital measurement systems listed in these packages are pre-established. Thus, a user is not burdened with having to understand the digital measurement systems themselves. Rather he or she simply selects a pre-packaged group based on the project they want to work on. For example, a user can be prompted to select a project. This project can correspond, for instance, to a website that is to be tagged or a campaign pathway journey involving multiple websites that are to be tagged. Each project has its own set of digital measurement systems pre-chosen for the project. In addition, in one version, one or more of these digital measurement systems can be customized for the project by limiting the digital tags to those that are deemed necessary for the project, thereby creating a custom taxonomy for the digital measurement system. This has the advantage of reducing the amount of information needed to be collected from the user. For example, on a Download Center project that focuses on file downloads, a taxonomy specific to tracking a download is made available.

Once the project has been selected, in one implementation, the user is asked to select from a set of one or more pre-packaged templates applicable to the selected project. Templates are pre-defined set of instructions that further limit the tagging choices associated with the digital measurement systems of the selected project, and so reduce the amount of information needed from the user. This works because some tasks involve fewer digital tags than others. Each template is pre-packaged to accomplish some task associated with the selected project. Thus, the user simply selects the template applicable to the task they want to perform.

### 1.1.3 Tag Areas

As indicated previously, for each web page which is to be tagged, one or more tag areas on the image representing the web page where digital measurement tags are to be located are identified by the user and the image coordinates of the area are received. In one implementation, this involves the user drawing a shape (e.g., a rectangle, square, circle, and so on) around the area on a displayed image of the page where a tag is to be placed.

### 1.1.4 Data and Triggering Event

As indicated previously, for each tag area on each image, the identity of the data that is to be captured and sent to a specified data collection system when a tag associated with the area is triggered, and the triggering event which causes this data to be captured, are received from the user.

In one implementation, the user is prompted to enter the identity of the data that is to be captured for each measurement area identified on a displayed image representing a web page, and the triggering event that is to cause the capture of the data. However, in another implementation designed to reduce the burden on the user, the user is prompted to select form a set of data scenarios each of which represents pre-established packages of one or more data items that are to be captured. Each of these packages group together data items that are specific to a data gathering task associated with the data scenario. Thus, a user is not burdened with having to identify the various data items that should be captured to accomplish a data gathering task. Rather he or she simply selects a pre-packaged group of data items deemed to be pertinent to the task, and specifies the triggering event for capturing the data.

However, in keeping with the desire to reduce the burden on the user, in one implementation, the user selects the triggering event for a measurement area first, and then selects a data scenario appropriate for the desired data gathering task. In this implementation, the data scenarios presented to the user are limited to those that are pre-determined to be appropriate for the specified triggering event.

Digital measurement tags can be triggered to capture specified data based on any web browser event, such as a page load, click, scroll, hover, and so on. For example, if the user chooses to capture data when a page is loaded, the types of data that it would be appropriate to capture at that point can be quite different from the types of data it would be appropriate to capture when a web page viewer clicks on a tagged icon. Thus, only those data scenarios that are deemed appropriate for a particular triggering event would be presented to the user, thereby simplifying he selection process.

In some circumstances the type of data that is to be collected is static in that its state does not vary and does not need to be specified by the user. In such cases the state of the data item can be automatically appended to the data item when it is captured. However, in other cases, the type of data identifies a category that can take on different states. In this latter case, the user is additionally prompted to specify a value indicative of a state of the data item. It is noted that in some circumstance, even though the state of a data item can vary, it will take on some value most of the time. In such a case, the state of the data item could be specified using a pre-established default value that the user can leave as is or change. Further, in a case where the state of the data item is dynamic, the value specified by the user could be instructions on how to acquire the data item's current state value.

For example, assume that it is desired to capture the name of a product, its current cost, and an action being requested by a web page viewer (e.g., buy, sell, rent, download, subscribe, and so on) in response to the viewer clicking on a tagged icon. In these circumstances, a data scenario is built that groups the data items “product”, “cost” and “desired action” together. Now take for example the “product” data item. The web page may be dedicated to a single product. In this case, the state of the data item (e.g., the product identity such as its category (tablet computer, smart phone, etc.), its brand name, model number, and so on) is fixed and can be automatically specified. In other cases, there may be multiple products that the tag could apply to on the page. In these cases, the user can be prompted to specify the state of the product data item (e.g., specify the category, brand name, model number, and so on). It is noted that the state of a data item might be automatically listed using a default state. In this case, the user can leave the default setting alone, or specify something different as desired. In yet other circumstances, the state of a data item may change over time. With a dynamic state, the state cannot be initially specified automatically or by the user as it could change by the time a web page viewer triggers the associated tag. In this case, the user can specify the state using instructions on how to acquire the current state of a data item. Thus, when the associated tag is triggered, part of the process of capturing the data is to access and capture the current state of a data item using the specified instructions. For example, the state of the aforementioned “cost” data item could change over time. Thus, when prompted, the user can specify instructions on how to acquire the current state of the cost.

With regard to specifying triggering events for a measurement area, it is noted that in one implementation more than one triggering event can be specified for the same measurement area and associated tag. In one version, any one of the plurality of triggering events can trigger the capturing of data. In another version, all of the specified triggering events have to occur before the capture of data is triggered.

### 1.2 Digital Tagging Specification

As indicated previously, a digital tagging specification is generated using the aforementioned user-input information. In one implementation, the digital tagging specification includes a tagging file for each user-input digital measurement system. This tagging file provides instructions on how to implement the digital measurement tags on the web pages represented by the user-input images using the digital measurement system associated with the file. In addition, the tagging file includes one or more images representing the web pages, along with the location of the one or more tag areas on each image where digital measurement tags are to be placed, and for each tag area, the identity of data that is to be captured and sent to a specified data collection system when a tag associated with the area is triggered, and the triggering event which causes the data specified by the tag associated with that tag area to be captured and sent to a specified data collection system.

In one implementation, the digital tagging specification's tagging instructions are intended to be used by a developer to implement the digital measurement tags on the aforementioned web pages. For example, the digital tagging specification can identify where in a web page's code base that tag code specific to a digital measurement system is to be inserted in order to implement a digital tag on one of the measurement areas. To this end, in one implementation, the digital tagging specification also includes program code specific to each of the user-input digital measurement systems for use by a developer to implement the digital measurement tags on the web pages.

### 1.3 Interactive User Interface

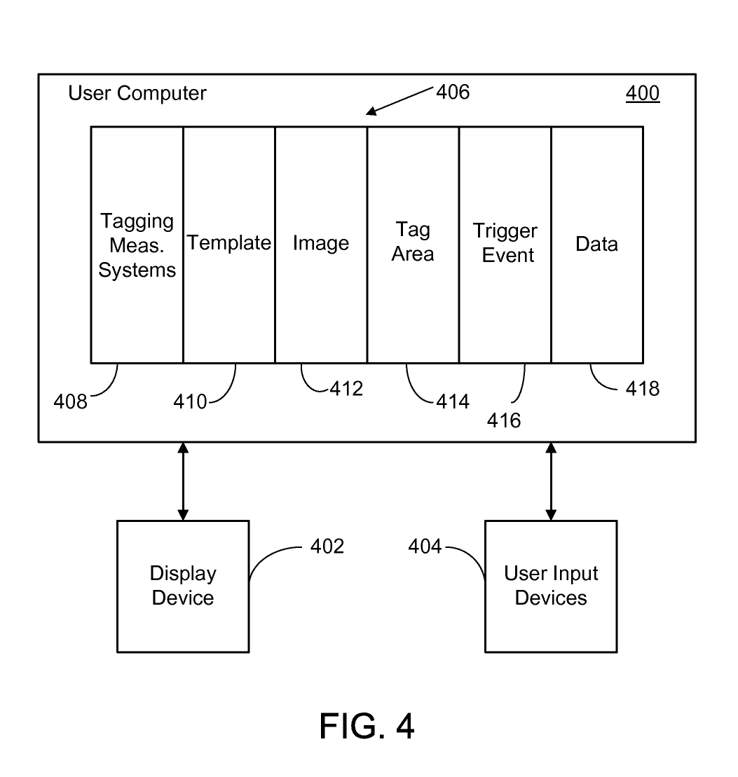

A series of interactive user interface pages are presented to a user which prompts the user to input the previously-described information used to generate the digital tagging specification. More particularly, referring to FIG. 4, in one exemplary implementation of a system for accomplishing this task, a computing device 400 comprising a display device 402 and user input devices 404 is employed. A computer program 406 having program modules executable by the computing device is also included. The computing device is directed by the program modules of the computer program to perform a series of interactive UI actions. The computing program includes a digital measurement systems module 408, a template module 410, an image module 412, a tag area module 414, a triggering event module 416, and a data module 418.

In one implementation, the digital measurement systems module 408 displays via the display device 402, a digital measurement system prompt inviting a user to input via one of the user input devices 404, the identity of one or more digital measurement systems that are to be used in generating the digital tagging specification. As described previously, this can be accomplished in one version by prompting the user to select certain icons representing packages identifying digital measurement systems for a specific project. To this end, an interactive user interface page can be displayed via the display device which depicts a series of one or more project icons each representing a tagging project the user can select. Each of the tagging projects represents one or more digital measurement systems that are pre-determined to be applicable to the tagging project. The mere presence of the project icon or icons can be viewed as the invitation to the user to select one. However, in one version, the interactive user interface page can also include instructions or links to instructions (via displayed text, symbols, images, audio, and so on) that invite the user to select one of the one or more project icons.

It is noted the aforementioned user input devices can take many forms. By way of example but not limitation, the user input devices can include a physical keyboard that is either integrated into the computing device or externally connected thereto in either a wired or wireless manner. The user input devices can also include a mouse that is externally connected to the computing device in either a wired or wireless manner. The user input devices can also include a trackpad (also known as a touchpad) that is either integrated into the computing device or externally connected thereto in either a wired or wireless manner. The user input devices can also include a handheld remote controller that is externally connected to the computing device in a wireless manner. In the case where the computing device is touch-enabled, the user input devices can also include finger-based screen-contacting gestures and stylus-based screen-contacting gestures that are made by a user. In the case where the computing device is voice-enabled, the user input devices can also include speech that a user utters. In the case where the computing device is vision-enabled, the user input devices can also include gaze-based gestures and hand-based in-air gestures that are made by a user.

Once the user inputs a selection, the digital measurement systems module 408 receives the project icon selection information indicating which of the one or more project icons the user selected. Then, in one implementation, the template module 410 displays via the display device 402, an interactive user interface page which depicts a series of one or more template icons each representing to a tagging task the user can select. More particularly, each template icon corresponds to a pre-defined set of instructions applicable to a tagging task that limit the tagging choices associated with the digital measurement systems of the selected project. Here again, the mere presence of the template icon or icons can be viewed as the invitation to the user to select one. However, in one version, the interactive user interface page can also include instructions or links to instructions (via displayed text, symbols, images, audio, and so on) that invite the user to select one of the one or more template icons. Once the user inputs a selection, the template module 410 receives the template icon selection information indicating which of the one or more template icons the user selected.

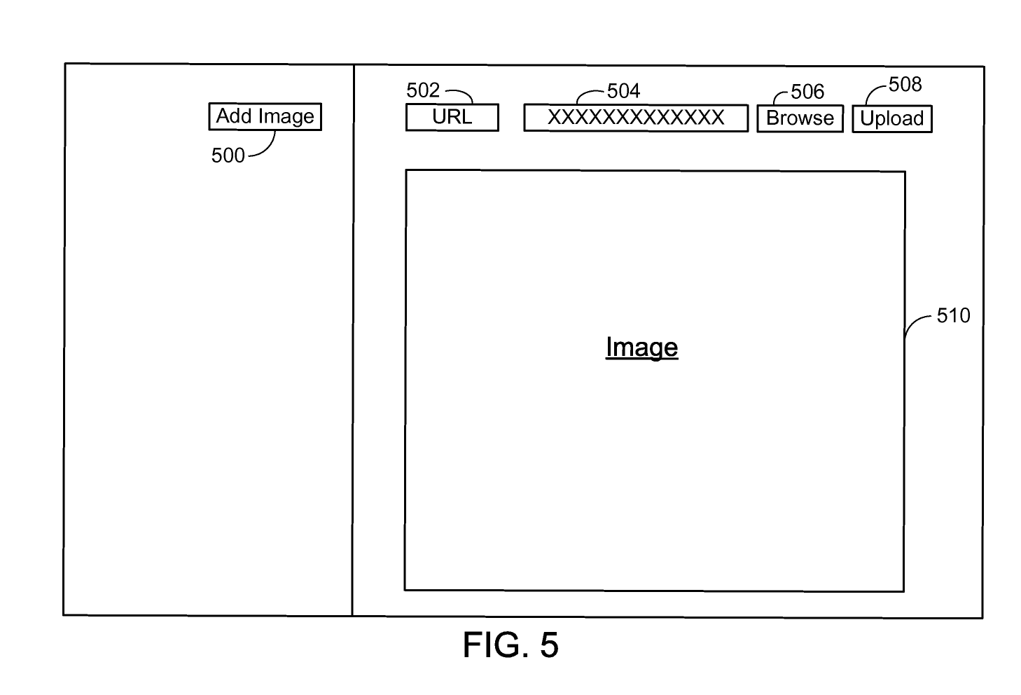

Next, the aforementioned image module 412 displays, via the display device 402, an image prompt inviting the user to input via one of said user input devices 404 one or more images representing web pages that are to be tagged with one or more digital measurement tags. To this end, an interactive user interface page, such as the exemplary page shown in FIG. 5, can be displayed via the display device which displays an add image button 500. In addition, a data entry box 502 is displayed for the user to identify whether an image is already available from a file share or the user's computer, or is to be accessed via a link (such as a URL) to a web page, as well as a data entry box 504 to enter the location of the image or the link address. In one version, a conventional browse button 506 is included so the user can search for and select the image or web page, rather than entering the location or address directly. Once the location or address is entered (directly or via the browse function), the user selects an upload button 508 to upload the image if a location is specified. If a link was specified, then the image is generated from the web page associated with the link as described previously. The image 510 is then displayed on the exemplary interactive user interface page of FIG. 5.

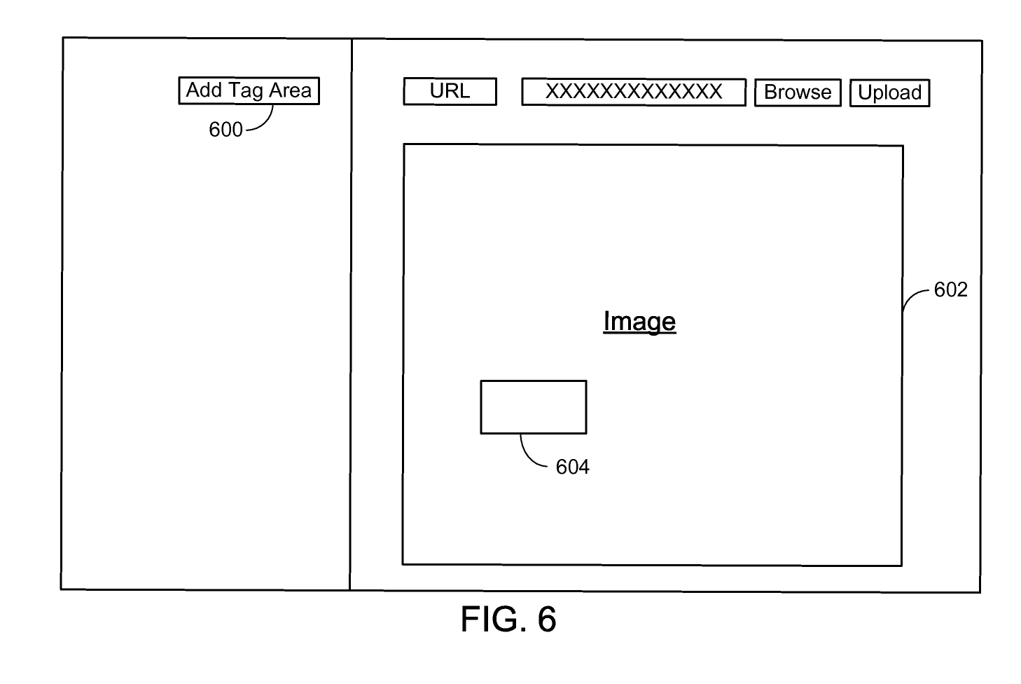

The aforementioned tag area module (414 of FIG. 4) then displays, via the display device, a tag area prompt inviting the user to input via one of said user input devices the location one or more tag areas on the displayed image where digital measurement tags are to be placed on the web page represented by the image. To this end, an interactive user interface page, such as the exemplary page shown in FIG. 6, displays an add tag area button 600. Each time the user selects this button 600, he or she can outline an area on the displayed image 602. For example, in FIG. 6, a box 604 is used to outline an area and is placed in the desired location by the user. Each time the user adds a tag area to the displayed image, the image coordinates representing an area outlined on the image by the user is received by the tag area module (414 of FIG. 4).

The triggering event module (416 of FIG. 4) then displays, via the display device, a triggering event prompt inviting the user to input via one of said user input devices a triggering event which causes the data specified by the tag associated with a tag area to be captured and sent to a specified data collection system. To this end, when the user selects a tag area on the image, an interactive user interface page displays a list of triggering events to choose from. The user is thus invited to select one or more of the triggering events and to specify whether the occurrence of any one of the selected triggering events triggers the tag associated with the selected tag area, or whether all the selected triggering events have to occur before the tag is triggered. This process is repeated for all the tag areas. Each time the user adds a triggering event to a tag area, the triggering information is received by the triggering event module (416 of FIG. 4).

Further, the data module (418 of FIG. 4) displays, via the display device, a data prompt inviting the user to input via one of said user input devices, for each tag area on the displayed image, the identity of the data that is to be captured and sent to a specified data collection system when a tag associated with the area is triggered. As described previously, in one version the foregoing data entry involves first displaying one or more user-selectable tag data icons each representing a set of one or more data items that are to be captured when the tag associated with the tag area under consideration is triggered. To this end, once a triggering event has been selected for a tag area on the displayed image, when the user selects a tag area again, an interactive user interface page displays the one or more tag data icons and invites the user to select one of them. Once again, the mere presence of the tag data icon or icons can be viewed as the invitation to the user to select one. However, in one version, instructions or links to instructions (via displayed text, symbols, images, audio, and so on) can be employed to invite the user to select one of the one or more tag data icons.

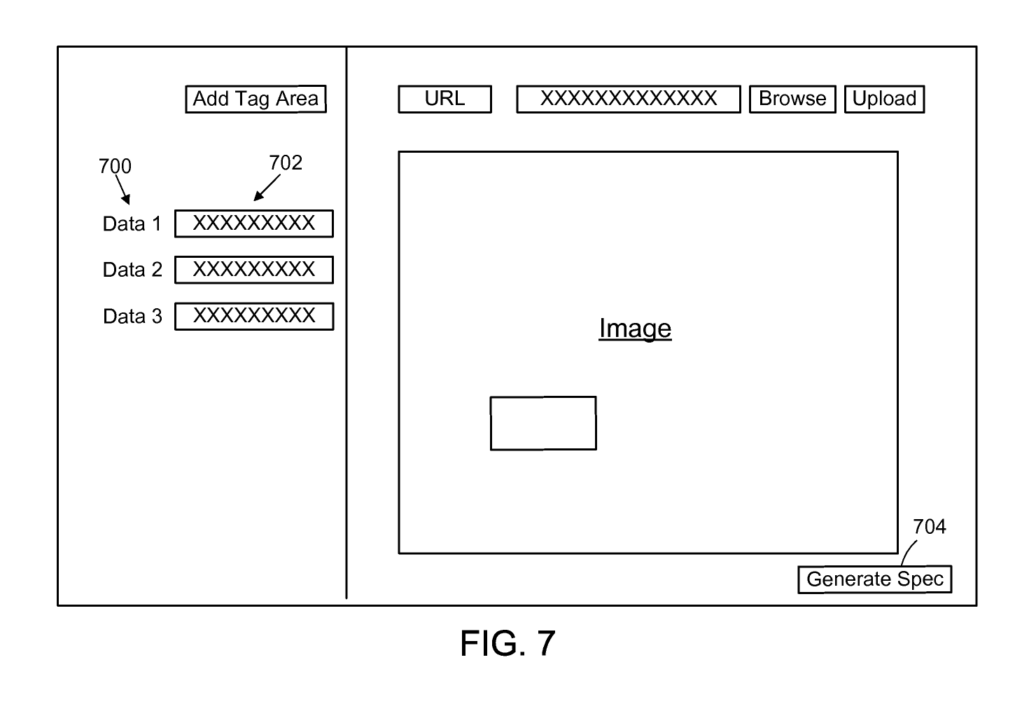

Once the user inputs a selection, the data module (418 of FIG. 4) receives tag data icon selection information indicating which of the one or more tag data icons the user selected. Then, in one implementation, the data module displays on an interactive user interface page, such as the exemplary page shown in FIG. 7, the data items 700 (three of which are shown) associated with the selected tag data icon and data entry boxes 702 for the user to enter a data item value indicative of a prescribed state of each data item. As indicated previously, sometimes the value for a data item is fixed and the data entry box for that data item is pre-filled with the fixed value and cannot be changed. However, sometimes the value for a data item is typically the same in most circumstances but other options are available. In this last case, the data entry box for that data item is pre-filled with the default value, but this value can be selected and changed either manually or by selecting from a list of possible values displayed on the exemplary interactive user interface page in response to the selection of the data box. Further, sometimes the value for a data item is open and the data entry box for that data item is blank. The user can select the empty box and fill it in manually or in one version select a value from a list displayed on the exemplary interactive user interface page in response to the selection of the data box. As described previously, the data entry value can be instructions on how to acquire a current data item value indicative of a state of a data item where the data item value is obtained using the instructions when the tag associated with the tag area is triggered. Once the user inputs the data item value selections, the data module (418 of FIG. 4) receives the data item information. This process of selecting a tag data icon and entering data item values is repeated for all the tag areas.

The foregoing actions of the image module (412 of FIG. 4), tag area module (414 of FIG. 4), triggering event module (416 of FIG. 4), and data module (418 of FIG. 4) are repeated for each image to which the user wishes to add digital tags. Once all the images have been processed, the user selects a digital tagging specification generating button displayed on an interactive user interface page, such as the Generating Spec button 704 in the exemplary page of FIG. 7, to initiate the digital tagging specification generation.

### 2.0 Exemplary Operating Environments

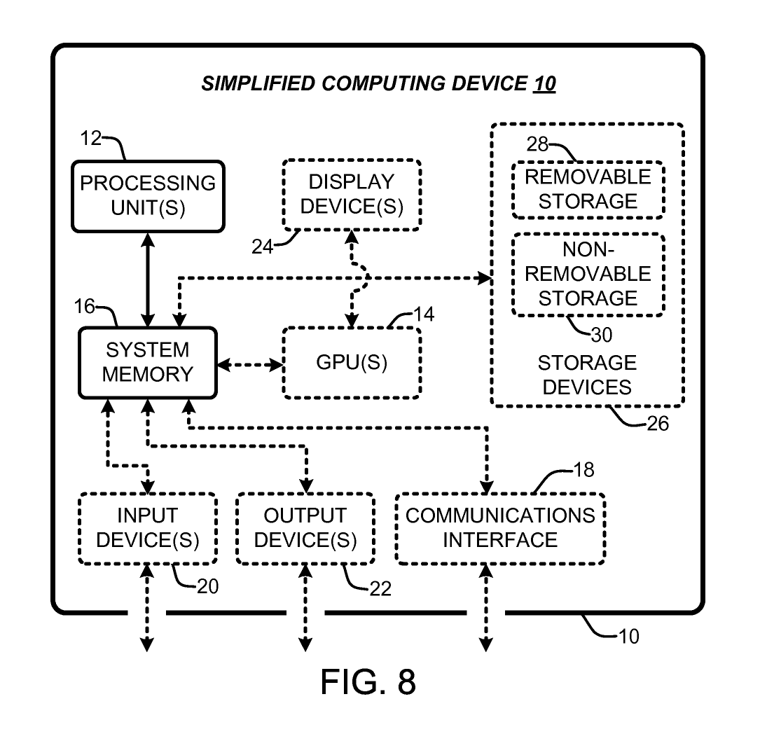

The digital tagging specification generating implementations described herein are operational using numerous types of general purpose or special purpose computing system environments or configurations. FIG. 8 illustrates a simplified example of a general-purpose computer system with which various aspects and elements of digital tagging specification generation, as described herein, may be implemented. It is noted that any boxes that are represented by broken or dashed lines in the simplified computing device 10 shown in FIG. 8 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To realize the digital tagging specification generating implementations described herein, the device should have a sufficient computational capability and system memory to enable basic computational operations. In particular, the computational capability of the simplified computing device 10 shown in FIG. 8 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of wearable sensing, including input, output, control, feedback, and response to one or more users or other devices or systems associated with digital tagging specification generation, are enabled by a variety of Natural User Interface (NUI) scenarios. The NUI techniques and scenarios enabled by digital tagging specification generation include, but are not limited to, interface technologies that allow one or more users user to interact in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors. Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the digital tagging specification generating implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the digital tagging specification generating implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 8 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various digital tagging specification generating implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The digital tagging specification generating implementations described herein may be further described in the general context of computer-executable instructions, such as program modules, being executed by a computing device. Generally, program modules include routines, programs, objects, components, data structures, and the like, that perform particular tasks or implement particular abstract data types. The digital tagging specification generating implementations described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

### 3.0 Other Implementations

While the foregoing descriptions of the various digital tagging specification generating implementations refer to tagging web pages of a website, it is noted that the same procedures can be employed to tag other digital items, such as an email, social media post, and so on. It is further noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Claim Support And Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation, a digital tagging specification generating system is employed. The system includes one or more computing devices each including a processor, communication interface and memory. If there are multiple computing devices, they are in communication with each other via a computer network. The system also includes a computer program having program modules executable by the one or more computing devices. The one or more computing devices are directed by the program modules of the computer program to: present a series of interactive user interface pages to a user which prompts the user to input information used to generate the digital tagging specification; receive user-input information which includes one or more images representing web pages each of which is to be tagged with one or more digital measurement tags, one or more digital measurement systems that are to be used in tagging said one or more web pages, for each web page which is to be tagged one or more tag areas on the image representing the web page where digital measurement tags are to be located, for each tag area on each image the identity of data that is to be captured and sent to a specified data collection system when a tag associated with the area is triggered, and a triggering event which causes the data specified by the tag associated with that tag area to be captured and sent to the specified data collection system; and generate a digital tagging specification using the received user-input information. In one version, the one or more images take the form of one or more sequences of images, where each image sequence represents a series of web pages that it is anticipated a viewer would view in sequential order. In one version, the digital tagging specification includes a tagging file for each user-input digital measurement system which provides instructions on how to implement the digital measurement tags on the web pages represented by the user-input images using that digital measurement system. This tagging file can include the one or more images representing the web pages, along with the location of the one or more tag areas on each image where digital measurement tags are to be placed, and for each tag area, the identity of data that is to be captured and sent to a specified data collection system when a tag associated with the area is triggered, and the triggering event which causes the data specified by the tag associated with that tag area to be captured and sent to a specified data collection system. In one version, the digital tagging specification includes tagging instructions specific to each of the user-input digital measurement systems for use by a developer to implement the digital measurement tags on said web pages. In one version, the digital tagging specification includes program code specific to each of the user-input digital measurement systems for use by a developer to implement the digital measurement tags on the web pages. In one version, the digital tagging specification includes both the aforementioned tagging instructions and program code.

In one implementation, a digital tagging specification generating system is employed that includes a computing device having a display device and user input devices. The system also includes a computer program having program modules executable by the computing device. The computing device is directed by the program modules of the computer program to: display via the display device a digital measurement systems prompt inviting a user to input via one of the user input devices the identity of one or more digital measurement systems that are to be used in generating the digital tagging specification; receive the user-inputted identity of one or more digital measurement systems; display via the display device an image prompt inviting the user to input via one of the user input devices one or more images representing web pages each of which is to be tagged with one or more digital measurement tags of the types employed by the one or more digital measurement systems; receive the user-inputted image or images. For each of the received images, the image is displayed via the display device, instructions are received that were input by the user via one of the user input devices that identify one or more tag areas on the displayed image where digital measurement tags are to be located on the web page represented by the image, a trigger prompt is display via the display device inviting the user to input via one of the user input devices, for each tag area on the displayed image, the triggering event which causes the data specified by the tag associated with that tag area to be captured and sent to a specified data collection system, for each tag area on the displayed image, receiving the triggering event which causes the data specified by the tag associated with that tag area to be captured and sent to a specified data collection system, a data prompt is displayed via the display device inviting the user to input via one of the user input devices, for each tag area on the displayed image, the identity of the data that is to be captured and sent to a specified data collection system when a tag associated with the area is triggered, for each tag area on the displayed image, and receiving the identity of the data that is to be captured and sent to a specified data collection system when a tag associated with the area is triggered. The computing device is also directed by the program modules of the computer program to generate a digital tagging specification using the received user-input information.

In one implementation, the program modules for displaying the digital measurement systems prompt inviting the user to input the identity of one or more digital measurement systems that are to be used in generating the digital tagging specification and receiving the user-inputted identity of one or more digital measurement systems, include sub-modules for: displaying via the display device a series of one or more project icons each representing a tagging project the user can select, each of the tagging projects including a list of one or more digital measurement systems that are pre-determined to be applicable to the tagging project and the prompt inviting the user to input the identity of one or more digital measurement systems includes inviting the user to select one of the one or more project icons; and receiving project icon selection information indicating which of the one or more project icons the user selected.

In one implementation, the computer program further includes program modules for performing, after the user-inputted identity of one or more digital measurement systems is received, the following: displaying via the display device a series of one or more template icons each representing a tagging task the user can select and corresponding to a pre-defined set of instructions applicable to the tagging task that limit the tagging choices associated with the digital measurement systems of the selected project and the digital measurement systems prompt inviting the user to input the identity of one or more digital measurement systems further includes inviting the user to select one of the one or more template icons; and receiving template icon selection information indicating which of the one or more template icons the user selected.

In one implementation, the program module for receiving instructions input by the user via one of the user input devices identifying one or more tag areas on the displayed image where digital measurement tags are to be located on the web page represented by the image, includes for each tag area, receiving image coordinates representing an area outlined on the image by the user.

In one implementation, the program modules for displaying via the display device the trigger prompt inviting the user to input via one of the user input devices, for each tag area on the displayed image, the triggering event which causes the data specified by the tag associated with that tag area to be captured and sent to a specified data collection system, and receiving, for each tag area on the displayed image, the triggering event which causes the data specified by the tag associated with that tag area to be captured and sent to a specified data collection system, include, for each tag area, sub-modules for: displaying via the display device a list of triggering events, inviting via the trigger prompt the user to select at least one triggering event from the list of triggering events; and receiving information indicating which triggering event or events the user selected.

In one implementation, the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, includes, for each tag area, sub-modules for: displaying via the display device one or more user-selectable tag data icons each representing a set of one or more data items that are to be captured when the tag associated with the tag area under consideration is triggered, where the data prompt inviting the user to input the identity of the data that is to be captured when a tag associated with the area is triggered, includes inviting the user to select one of the one or more tag data icons; and receiving tag data icon selection information indicating which of the one or more tag data icons the user selected.

In one implementation, the sub-module for displaying one or more user-selectable tag data icons each representing a set of one or more data items that are to be captured when the tag associated with the tag area under consideration is triggered, includes displaying one or more user-selectable tag data icons that are pre-determined to be appropriate for a triggering event chosen for the tag.

In one implementation, the sub-module for displaying one or more user-selectable tag data icons each representing a set of one or more data items that are to be captured when the tag associated with the tag area under consideration is triggered, includes for at least one tag data icon, grouping together data items in the tag data icon that are specific to a data gathering task associated with the tag data icon.

In one implementation, the identity of the data that is to be captured includes both a data item and a data item value indicative of a prescribed state of the data item.

In one implementation, the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, further include, for each tag area, sub-modules for: whenever tag data icon selection information indicating which of the one or more tag data icons the user selected is received, displaying via the display device a second data prompt inviting the user to input, for at least one data item associated with the selected tag data icon, a data item value indicative of a state of the data item; and receiving the prescribed state of each data item the user inputs.

In one implementation, the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, further include, for each tag area, sub-modules for: wherever tag data icon selection information indicating which of the one or more tag data icons the user selected is received, displaying via the display device a second data prompt inviting the user to input, for at least one data item associated with the selected tag data icon, instructions on how to acquire a current data item value indicative of a state of the data item where the data item value is to be obtained using the instructions when the tag associated with the area under consideration is triggered; and receiving the instructions on how to acquire the data item value indicative of the prescribed state of the data item for each data item value instructions the user inputs.

In one implementation, a computer-implemented process is employed for generating a digital tagging specification that uses a computing device to perform the following process actions. First, a series of interactive user interface pages is presented to a user which prompts the user to input information used to generate the digital tagging specification. User-input information is then received which includes one or more images representing web pages each of which is to be tagged with one or more digital measurement tags, one or more digital measurement systems that are to be used in tagging said one or more web pages, for each web page which is to be tagged one or more tag areas on the image representing the web page where digital measurement tags are to be located, for each tag area on each image the identity of data that is to be captured and sent to a specified data collection system when a tag associated with the area is triggered, and the triggering event which causes the data specified by the tag associated with that tag area to be captured and sent to a specified data collection system. A digital tagging specification is then generated using the received user-input information. In one version, the process action of receiving user-input information which has one or more images includes the actions of: receiving a link to at least one web page; for each link received, using the link to access the associated web page, scraping the accessed web page, and capturing a screen shot of the scrapped page. Further, in one version, the accessed web page includes dynamic data, and the action of scraping the accessed web page, includes the actions of scrolling the entire web page and loading any dynamic content associated with the webpage before capturing a screen shot of the scrapped page.

In one implementation, generating a digital tagging specification includes using a computing device to perform the following process actions: an presenting step for presenting a series of interactive user interface pages to a user which prompts the user to input information used to generate the digital tagging specification; a receiving step for receiving user-input information which includes one or more images representing web pages each of which is to be tagged with one or more digital measurement tags, one or more digital measurement systems that are to be used in tagging said one or more web pages, for each web page which is to be tagged one or more tag areas on the image representing the web page where digital measurement tags are to be located, for each tag area on each image the identity of data that is to be captured and sent to a specified data collection system when a tag associated with the area is triggered, and the triggering event which causes the data specified by the tag associated with that tag area to be captured and sent to a specified data collection system, and a generating step for generating a digital tagging specification using the received user-input information.

In one implementation, generating a digital tagging specification includes using a computing device having a display device and user input devices to perform the following process actions: a digital measurement systems prompt displaying step for displaying via the display device a digital measurement systems prompt inviting a user to input via one of the user input devices the identity of one or more digital measurement systems that are to be used in generating the digital tagging specification; a digital measurement systems receiving step for receiving the user-inputted identity of one or more digital measurement systems; an image prompt displaying step for displaying via the display device an image prompt inviting the user to input via one of the user input devices one or more images representing web pages each of which is to be tagged with one or more digital measurement tags of the types employed by the one or more digital measurement systems; an image receiving step for receiving the user-inputted image or images. For each of the received images, the image is displayed via the display device, and the computing device is used to perform the following steps: an instructions receiving step for receiving instructions that were input by the user via one of the user input devices that identify one or more tag areas on the displayed image where digital measurement tags are to be located on the web page represented by the image, a trigger prompt displaying step for displaying a trigger prompt via the display device inviting the user to input via one of the user input devices, for each tag area on the displayed image, the triggering event which causes the data specified by the tag associated with that tag area to be captured and sent to a specified data collection system; and for each tag area on the displayed image, a triggering event receiving step for receiving the triggering event which causes the data specified by the tag associated with that tag area to be captured and sent to a specified data collection system; a data prompt displaying step for displaying a data prompt via the display device inviting the user to input via one of the user input devices, for each tag area on the displayed image, the identity of the data that is to be captured and sent to a specified data collection system when a tag associated with the area is triggered; and a data identity receiving step for receiving the identity of the data that is to be captured and sent to a specified data collection system when a tag associated with the area is triggered. The computing device is then used to perform a generating step for generating a digital tagging specification using the received user-input information.

Wherefore, what is claimed is:

1. A system for generating a digital tagging specification, comprising:
one or more computing devices each comprising a processor, communication interface and memory, wherein said computing devices are in communication with each other via a computer network whenever there are multiple computing devices;
a computer program having program modules executable by the computing device or devices, the computing device or devices being directed by the program modules of the computer program to,
present a series of interactive user interface pages to a user which prompts the user to input information used to generate the digital tagging specification,
receive user-input information which comprises,
one or more images representing web pages each of which is to be tagged with one or more digital measurement tags;
one or more digital measurement systems that are to be used in tagging said one or more web pages,
for each web page which is to be tagged, one or more tag areas on the image representing the web page where digital measurement tags are to be located,
for each tag area on each image,
the identity of data that is to be captured and sent to a specified data collection system when a tag associated with the area is triggered, and
a triggering event which causes the data specified by the tag associated with that tag area to be captured and sent to the specified data collection system, and
generate a digital tagging specification using the received user-input information.

2. The system of claim 1, wherein the one or more images take the form of one or more sequences of images, each image sequence representing a series of web pages that it is anticipated a viewer would view in sequential order.

3. The system of claim 1, wherein the digital tagging specification comprises a tagging file for each user-input digital measurement system which provides instructions on how to implement said digital measurement tags on said web pages represented by the user-input images using that digital measurement system.

4. The system of claim 3, wherein each tagging file comprises the one or more images representing said web pages, along with the location of the one or more tag areas on each image where digital measurement tags are to be placed, and for each tag area, the identity of data that is to be captured and sent to a specified data collection system when a tag associated with the area is triggered, and the triggering event which causes the data specified by the tag associated with that tag area to be captured and sent to a specified data collection system.

5. The system of claim 1, wherein the digital tagging specification comprises tagging instructions specific to each of the user-input digital measurement systems for use by a developer to implement said digital measurement tags on said web pages.

6. The system of claim 1, wherein the digital tagging specification comprises program code specific to each of the user-input digital measurement systems for use by a developer to implement said digital measurement tags on said web pages.

7. A system for generating a digital tagging specification, comprising:
a computing device comprising a display device and user input devices; and
a computer program having program modules executable by the computing device, the computing device being directed by the program modules of the computer program to,
display via said display device a digital measurement systems prompt inviting a user to input via said one of said user input devices the identity of one or more digital measurement systems that are to be used in generating the digital tagging specification,
receive the user-inputted identity of one or more digital measurement systems,
display via said display device an image prompt inviting the user to input via one of said user input devices one or more images representing web pages each of which is to be tagged with one or more digital measurement tags of the types employed by said one or more digital measurement systems;
receive the user-inputted image or images,
for each of the received images,
display the image via said display device,
receive instructions input by the user via one of said user input devices identifying one or more tag areas on the displayed image where digital measurement tags are to be located on the web page represented by the image,
display via said display device a trigger prompt inviting the user to input via one of said user input devices, for each tag area on the displayed image, the triggering event which causes the data specified by the tag associated with that tag area to be captured and sent to a specified data collection system,
receive, for each tag area on the displayed image, the triggering event which causes the data specified by the tag associated with that tag area to be captured and sent to a specified data collection system,
display via said display device a data prompt inviting the user to input via one of said user input devices, for each tag area on the displayed image, the identity of the data that is to be captured and sent to a specified data collection system when a tag associated with the area is triggered,
receive, for each tag area on the displayed image, the identity of the data that is to be captured and sent to a specified data collection system when a tag associated with the area is triggered, and
generate a digital tagging specification using the received user-input information.

8. The system of claim 7, wherein the program modules for displaying the digital measurement systems prompt inviting the user to input the identity of one or more digital measurement systems that are to be used in generating the digital tagging specification and receiving the user-inputted identity of one or more digital measurement systems, comprise sub-modules for:
displaying via said display device a series of one or more project icons each representing a tagging project the user can select, each of said tagging projects comprising a list of one or more digital measurement systems that are pre-determined to be applicable to the tagging project and said prompt inviting the user to input the identity of one or more digital measurement systems comprises inviting the user to select one of the one or more project icons; and
receiving project icon selection information indicating which of the one or more project icons the user selected.

9. The system of claim 7, wherein the computer program further comprising program modules for performing, after the user-inputted identity of one or more digital measurement systems is received, the following:
displaying via said display device a series of one or more template icons each representing a tagging task the user can select and corresponding to a pre-defined set of instructions applicable to the tagging task that limit the tagging choices associated with the digital measurement systems of the selected project and said digital measurement systems prompt inviting the user to input the identity of one or more digital measurement systems further comprises inviting the user to select one of the one or more template icons; and
receiving template icon selection information indicating which of the one or more template icons the user selected.

10. The system of claim 7, wherein the program module for receiving instructions input by the user via one of said user input devices identifying one or more tag areas on the displayed image where digital measurement tags are to be located on the web page represented by the image, comprises for each tag area, receiving image coordinates representing an area outlined on the image by the user.

11. The system of claim 7, wherein the program modules for displaying via said display device the trigger prompt inviting the user to input via one of said user input devices, for each tag area on the displayed image, the triggering event which causes the data specified by the tag associated with that tag area to be captured and sent to a specified data collection system, and receiving, for each tag area on the displayed image, the triggering event which causes the data specified by the tag associated with that tag area to be captured and sent to a specified data collection system, comprise, for each tag area, sub-modules for:
displaying via said display device a list of triggering events, said trigger prompt inviting the user to select at least one triggering event from the list of triggering events; and
receiving information indicating which triggering event or events the user selected.

12. The system of claim 7, wherein the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, comprises, for each tag area, sub-modules for:
displaying via said display device one or more user-selectable tag data icons each representing a set of one or more data items that are to be captured when the tag associated with the tag area under consideration is triggered, said data prompt inviting the user to input the identity of the data that is to be captured when a tag associated with the area is triggered, comprises inviting the user to select one of the one or more tag data icons; and
receiving tag data icon selection information indicating which of the one or more tag data icons the user selected.

13. The system of claim 12, wherein the sub-module for displaying one or more user-selectable tag data icons each representing a set of one or more data items that are to be captured when the tag associated with the tag area under consideration is triggered, comprises displaying one or more user-selectable tag data icons that are pre-determined to be appropriate for a triggering event chosen for the tag.

14. The system of claim 12, wherein the sub-module for displaying one or more user-selectable tag data icons each representing a set of one or more data items that are to be captured when the tag associated with the tag area under consideration is triggered, comprises for at least one tag data icon, grouping together data items in the tag data icon that are specific to a data gathering task associated with the tag data icon.

15. The system of claim 12, wherein said identity of the data that is to be captured comprises both a data item and a data item value indicative of a prescribed state of the data item.

16. The system of claim 12, wherein the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, further comprise, for each tag area, sub-modules for:
whenever tag data icon selection information indicating which of the one or more tag data icons the user selected is received, displaying via said display device a second data prompt inviting the user to input, for at least one data item associated with the selected tag data icon, a data item value indicative of a state of the data item; and
receiving said prescribed state of each data item the user inputs.

17. The system of claim 12, wherein the program modules for displaying the data prompt inviting the user to input, for each tag area on the displayed image, the identity of the data that is to be captured when a tag associated with the area is triggered, and receiving, for each tag area on the displayed image, the identity of the data that is to be captured and sent to a specified data collection system when a tag associated with the area is triggered, further comprise, for each tag area, sub-modules for:
wherever tag data icon selection information indicating which of the one or more tag data icons the user selected is received, displaying via said display device a second data prompt inviting the user to input, for at least one data item associated with the selected tag data icon, instructions on how to acquire a current data item value indicative of a state of the data item wherein said data item value is to be obtained using the instructions when the tag associated with the area under consideration is triggered; and
receiving said instructions on how to acquire the data item value indicative of the prescribed state of the data item for each data item value instructions the user inputs.

18. A computer-implemented process for generating a digital tagging specification, comprising:
using a computing device to perform the following process actions:
presenting a series of interactive user interface pages to a user which prompts the user to input information used to generate the digital tagging specification;
receiving user-input information which comprises,
one or more images representing web pages each of which is to be tagged with one or more digital measurement tags,
one or more digital measurement systems that are to be used in tagging said one or more web pages,
for each web page which is to be tagged, one or more tag areas on the image representing the web page where digital measurement tags are to be located,
for each tag area on each image,
the identity of data that is to be captured and sent to a specified data collection system when a tag associated with the area is triggered, and
the triggering event which causes the data specified by the tag associated with that tag area to be captured and sent to a specified data collection system; and
generating a digital tagging specification using the received user-input information.

19. The process of claim 18, wherein the process action of receiving user-input information which comprises one or more images comprises the actions of:
receiving a link to at least one web page;
for each link received,
using the link to access the associated web page,
scraping the accessed web page, and
capturing a screen shot of the scrapped page.

20. The process of claim 19, wherein the accessed web page comprises dynamic data, and wherein the action of scraping the accessed web page, comprises the actions of scrolling the entire web page and loading any dynamic content associated with the webpage before capturing a screen shot of the scrapped page.
